(19) United States
(12) Patent Application Publication
(10) Pub. No.: US 2026/0064673 A1
(43) Pub. Date: Mar. 5, 2026

(54) RETRIEVAL AUGMENTED THOUGHT FOR AGENTIC MODELS

(71) Applicant: Ancestry.com Operations Inc., Lehi, UT (US)

(72) Inventors: Xiaoxuan Zhang, San Francisco, CA (US); Glen Brewer Lewis, Lehi, UT (US)

(21) Appl. No.: 19/287,330

(22) Filed: Jul. 31, 2025

Related U.S. Application Data
(60) Provisional application No. 63/688,580, filed on Aug. 29, 2024.

(51) Int. Cl. G06F 16/245

(52) U.S. Cl. CPC G06F 16/245

(57) ABSTRACT

The present disclosure is directed toward systems, methods, and non-transitory computer-readable media for a retrieval augmented thought approach to generating responses using neural networks. For example, the disclosed systems can receive a prompt instruction a large language model to generate a response. The disclosed systems can identify a retrieval-augmented-thought (RAT) store item corresponding to the prompt from among RAT-store items stored in a repository accessible by the large language model. In some cases, the disclosed systems can retrieve the RAT-store item and can generate a response using the large language model to execute processes defined by the RAT-store item. Further, in some cases, the disclosed systems utilize a dynamic graph-based agentic framework that incorporates one or more functional adapters and a RAT replanner to execute a sequence of processes indicated by a RAT-store item in a sequential manner.

### CROSS-REFERENCE TO RELATED APPLICATIONS

This application claims priority to and the benefit of U.S. Provisional Patent Application No. 63/688,580, filed on Aug. 29, 2024, which is incorporated herein by reference in its entirety.

### BACKGROUND

Recent years have seen significant developments in artificial intelligence (AI) software and usage of large language models. Indeed, the increased popularity of large language models and the ever-evolving context of the internet has led to AI, and more specifically to large language models performing an enormous array of tasks, including generating, summarizing, translating, and classifying digital content. Based on the ever-increasing capabilities of large language models, some existing systems integrate large language models into programming architecture, data analysis pipelines, or other data processing systems. For example, some existing systems utilize retrieval augmented generators (RAGs) to retrieve information and generate responses to queries. Despite these advances, some existing systems exhibit a number of problems, particularly in relation to computational efficiency and accuracy.

As just suggested, certain existing RAG-based systems are computationally inefficient, or at least leave room for improvement in resource consumption. While RAG-based systems can use generative models to identify and analyze relevant digital content for generating responses, a large language model often requires fine-tuning to generate a response specific to a particular task within a RAG framework. Such fine-tuning can require thousands, tens of thousands, or even millions of examples to teach the large language model to generate responses for a task. Not only does generating the example content items for fine-tuning consume excessive amounts of computational resources (such as processing power, memory, and storage) but performing the fine-tuning itself is also computationally expensive. Fine-tuning a RAG-based large language model is sometimes split into two parts-fine—tuning the retrieval model and fine-tuning the generative model—and can include many iterations or epochs (for both models) of providing sample data, generating predicted responses, applying a loss function (e.g., a contrastive loss function or a cross-entropy loss function) based on the predicted responses, and adjusting model parameters to improve model predictions. This fine-tuning process is computationally intensive and consumes excessive amounts of computer resources that could otherwise be preserved in a more efficient system.

In addition to their inefficiencies, many existing systems are inaccurate. Specifically, existing large-language-model-based systems often generate inaccurate content based on their overgeneralized knowledge base used in the fine-tuning process. For example, many existing large language models depend on a wide-ranging database that includes vast amounts of data across a huge variety of topics and fields. If the database is incomplete, biased, or sparse on particular content, the large language model generates inaccurate and irrelevant responses. Moreover, many existing large language models are trained over enormous databases of common general data to achieve broad coverage of output generation across a wide array of contexts. Unfortunately, a consequence of such wide-ranging and generalized training (on sometimes biased data) is that the resulting large language models often hallucinate, generating erroneous, irrelevant, or incorrect responses (or other outputs) that the models treat as true. Without ways to ameliorate the inaccurate outputs generated by existing large language models, many conventional systems produce unreliable outputs, especially in specific domains such as genealogical data, which negatively affect downstream analysis and/or use of such outputs.

### SUMMARY

This disclosure describes one or more embodiments of systems, methods, and non-transitory computer-readable storage media that provide benefits and/or solve one or more of the foregoing and other problems in the art. In particular, the disclosed systems introduce a unique approach for informing or instructing agentic models (and underlying large language models) through retrieval-augmented thought (RAT), which can improve planning and reasoning processes. In some embodiments, this unique approach may serve as an alternative to retrieval augmented generation (RAG). For example, the disclosed systems can generate and/or access a RAT database that includes RAT-store items which include text descriptions of expert-generated examples and/or instructions interpretable by an agentic model (e.g., using a large language model) to generate a target response. By accessing a RAT-store item from the RAT database, the disclosed systems can generate a target response without fine-tuning and without multi-shot prompt-and-response approaches prevalent in existing systems. Indeed, in response to a single prompt, the disclosed systems can identify and access a relevant RAT-store item and can execute processes indicated by the RAT-store item to generate a target response.

In some cases, the disclosed systems can generate RAT-store items by combining other existing RAT-store items and/or by extracting and synthesizing content from other content items. Further, in some cases, the disclosed systems utilize a dynamic graph-based agentic framework that incorporates one or more functional adapters and a RAT replanner to execute a sequence of processes indicated by a RAT-store item in a sequential manner. The disclosed systems may also utilize the RAT replanner to determine replanner data (e.g., replanner “tips”) that may be used to provide contextual data for informing execution of a subsequent process of the sequence of processes.

### BRIEF DESCRIPTION OF THE DRAWINGS

The detailed description provides one or more embodiments with additional specificity and detail through the use of the accompanying drawings, as briefly described below.

FIG. 1 illustrates a schematic diagram of an example environment of a model-modification system in accordance with one or more embodiments.

FIG. 2 illustrates an example overview of the model-modification system and the interaction of its components, including an agentic system, a large language model, a RAG model, and a RAT model in accordance with one or more embodiments.

FIG. 3 illustrates an example diagram of using retrieval-augmented thought for a large language model to generate a response in accordance with one or more embodiments.

FIG. 4 illustrates an example diagram for storing and utilizing RAT-store items in accordance with one or more embodiments.

FIG. 5 illustrates an example diagram for generating a response using a RAT-store item in accordance with one or more embodiments.

FIG. 6 illustrates an example diagram of modifying parameters within a model-modification system to improve response accuracy in accordance with one or more embodiments.

FIG. 7 illustrates an example diagram of a graph-based agentic framework associated with (or utilized by) the model-modification system in accordance with one or more embodiments.

FIG. 8. illustrates an example interface for generating responses using a model-modification system in accordance with one or more embodiments.

FIG. 9 illustrates a tree database and a cluster database of a genealogical-data system in accordance with one or more embodiments.

FIG. 10 illustrates an example flowchart of a series of acts for generating a response using a RAT store item in accordance with one or more embodiments.

FIG. 11 illustrates a block diagram of an exemplary computing device in accordance with one or more embodiments.

FIG. 12 illustrates an exemplary computing environment in accordance with one or more embodiments.

### DETAILED DESCRIPTION

This disclosure describes one or more embodiments of a model-modification system that can augment the chain-of-thought processing of an agentic model (and/or an underlying large language model) using specially curated stored data, such as instructions sets for performing particular tasks and/or examples of responses corresponding to particular prompts. In certain use cases, user accounts interact with client devices to search or otherwise access genealogical databases to perform particular tasks. For instance, user accounts search for genealogical content items (e.g., birth certificates, digitized newspaper articles, images, census records, obituaries, court documents, military records, immigration records, and other types of digitized historical documents) to identify family members to link within genealogy trees stored within one or more genealogy tree databases and/or to add genealogical content items to existing nodes within genealogy trees. As part of this process, the model-modification system can utilize a large language model to generate a response that indicates members of a family tree in response to a prompt requesting such information, where the model-modification system generates the response by accessing a text description interpretable by the large language model to inform its chain-of-thought response generation.

To elaborate on the retrieval-augmented chain of thought, in some embodiments, the model-modification system determines that a particular agentic model, such as a large language model, cannot (with a threshold degree of confidence or accuracy) generate a response to a received prompt based on its already learned parameters. Based on such a determination, the model-modification system can search a repository of RAT-store items that include text descriptions of tuning data interpretable by the large language model to inform or augment its chain of thought (e.g., its internal parameters). For instance, the RAT-store items can include expert-generated instruction sets and/or examples of generated responses specific to the received prompt.

The model-modification system can thus analyze the RAT-store items using the large language model to identify one or more RAT-store items that correspond to the prompt. In some embodiments, the model-modification system further utilizes the large language model to execute processes defined by the text descriptions in an identified RAT-store item (e.g., by executing processes indicated by text descriptions of processes in an instruction set or by generating a response matching a provided example corresponding to the prompt). Through this process, the model-modification system uses a one-shot approach to informing a large language model for generating responses to prompts that the large language model could not previously process. Upon (or as part of) informing the large language model to perform the new processes indicated by the text descriptions of a RAT-store item, the model-modification system can further perform additional processes, such as accessing additional content items to generate a response for the prompt (e.g., in a retrieval-augmented generation or RAG approach).

As suggested above, in one or more embodiments, the model-modification system utilizes this type of chain-of-thought augmentation in the context of genealogical data. For example, the model-modification system receives a prompt to identify family members belonging to a particular family tree stored in a genealogical database. In response to determining that available large language models cannot accurately generate a response for the prompt using existing learned parameters and available RAG data, the model-modification system accesses a RAT store to (in a one-shot approach) learn and/or implement the processes involved in generating a response for the prompt. For instance, the model-modification system identifies a RAT-store item that includes text descriptions of instructions (e.g., a series of processes or tasks to execute) and/or examples corresponding to identifying family members of the family tree (e.g., with specific naming conventions of the family tree and/or indications of databases storing relevant content items associated with the family tree). The model-modification system further utilizes the large language model to execute processes for the text descriptions of the RAT-store item which can instruct the large language model to access RAG databases of genealogical content items as part of generating a response for the prompt—e.g., generating a list of family members belonging to the family tree.

Further, the model-modification system may utilize a graph-based agentic framework (e.g., a LangGraph framework) to determine and/or sequentially execute (or perform) one or more processes indicated by a RAT-store item. Specifically, the model-modification system may utilize a large language model incorporated by the graph-based agentic framework to determine and execute a sequence of processes indicated by the RAT-store item. As an example, the model-modification system may utilize the large language model and one or more function adapters to execute a first process of the sequence of processes (e.g., in isolation of other, downstream processes of the sequence of processes). Upon executing the first process, the model-modification system can utilize a RAT replanner to execute one or more additional processes from the sequence of processes, where each may be executed one at a time or in isolation of other processes of the sequence of processes (e.g., to avoid overlapping processes). Additionally or alternatively, the model-modification system 102 may utilize the RAT replanner to determine replanner data that may be used to provide contextual data for informing execution of a subsequent process of the sequence of processes by the large language model after execution of a particular process.

As suggested above, the model-modification system can provide improvements or advantages over existing historical content systems. For example, the model-modification system can improve computational efficiency over prior systems. Compared to prior agentic model systems, such as RAG-based systems that fine tune model parameters over multiple iterations (or multiple shots) on large databases, the model-modification system uses a one-shot approach to instruct a large language model on new processes not previously executable (with a threshold accuracy). Indeed, the model-modification system can identify and process expert-generated RAT data (e.g., text descriptions of instructions or examples) to inform a large language model for performing a particular task or generate a particular response. Thus, rather than consuming excessive computer resources in generating and storing large fine-tuning databases and performing fine-tuning operations over many iterations, the model-modification system preserves vast amounts of computer resources through instructing agentic systems (and underlying large language models) in a one-shot approach using RAT-store items. Research has shown that embodiments of the model-modification system can reduce computational expense by up to three or four orders of magnitude in some cases.

In addition to improving computational efficiency, the model-modification system can also improve accuracy. For example, the model-modification system can more accurately generate responses to prompts compared to prior agentic systems, such as RAG-based systems and other large-language-model-based systems. While many existing systems generate inaccurate responses due to training on overgeneralized databases and/or accessing sparse content for a particular task, the model-modification system can generate much more accurate, precise responses that are less prone to hallucination due to learning over RAT-store items. Indeed, the model-modification system can generate, store, and access RAT-store items that are expert-generated and that include text data interpretable by a large language model to execute specific tasks. Specifically in the realm of genealogical information, the model-modification system can (in response to determining that a model is not yet capable of performing a task) access a RAT-store item that provides text descriptions for locating particular genealogical data, modifying family trees, or generating genealogical content items such that a large language model executes to perform such processes upon accessing and analyzing the RAT-store item. Existing systems, on the other hand, are either incapable of performing new tasks or generate inaccurate responses when performing new tasks because existing retrieval data (e.g., for RAGs) and model parameters are sparse regarding new tasks.

Moreover, the model-modification system can also improve accuracy by utilizing a dynamic graph-based agentic framework (e.g., a LangGraph framework) that may incorporate a RAT replanner. For instance, the model-modification system can utilize the graph-based agentic framework and the RAT replanner to determine and/or execute (or perform) a sequence of processes indicated by a RAT-store item in a sequential manner, where each process in the sequence of processes may be executed one at a time. In some cases, the model-modification system utilizes the RAT replanner to determine and select, from a replanner-data store, replanner data that may include contextual data for informing execution of a subsequent process in the sequence of processes. For example, upon executing a first process of a sequence of processes, the model-modification system may leverage the RAT replanner to select replanner data for executing a second process of the sequence of processes with contextual information relevant to that process. Not only does this approach allow the model-modification system to maintain clarity and avoid cross-process interference, but it may also allow the model-modification system to perform processes with improved accuracy and situational relevance by incorporating replanner data.

That is, the incorporation of replanner data—facilitating context-specific tips to improve execution of remaining processes of the sequence of processes determined based on the RAT-store item—advantageously utilizes the growing conversational context—which may include insights determined from results, records, generated responses, etc. from previously executed processes of the sequence of processes and/or context-specific tips determined based on selected replanner-data store items—in addition or alternatively to the narrowing focus of the sequence of processes (as previously executed processes are removed from the sequence of processes by the replanner) to generate accurate and insightful results based on context-specific best practices while also preventing the model—modification system from entering an endless loop of continually updating sequences of processes.

As illustrated by the foregoing discussion, the present disclosure utilizes a variety of terms to describe features and benefits of the model-modification system. Additional detail is hereafter provided regarding the meaning of these terms as used in this disclosure. Further, while this disclosure focuses primarily on genealogical content in the context of a genealogical-data system, the model-modification system can perform one or more of the processes described herein in the context of other types of digital content items and data systems as well.

As used herein, the term “genealogical content item” (or sometimes simply “content item”) refers to a digital object or a digital file that includes information (e.g., genealogical information) interpretable by a computing device (e.g., a client device) to present information to a user. A content item can include a file such as a digital text file, a digital image file, a digital audio file, a webpage, a website, a digital video file, a web file, a link, a digital document file, or some other type of file or digital object. A content item can have a particular file type or file format, which may differ for different types of digital content items (e.g., digital documents, digital images, digital videos, or digital audio files). In some cases, a content item can refer to a genealogical content item that includes or depicts historical or genealogical information, such as a birth certificate, a digitized newspaper article, a digitized photograph of a relative, a digitized census record, a digitized obituary, a digitized court document, a digitized DNA analysis, or a digitized family tree. In some embodiments, a genealogical content item includes a content item selected or identified to surface to a client device, such as an item in a search result, a record hint (e.g., a stored or generated genealogical content item surfaced as a suggestion for a user account), a digital story (e.g., a stored collection of genealogical content items arranged for a particular person, topic, or entity of a genealogical-data system), a digital image (e.g., a digitized photograph), a new person hint (e.g., a suggested node to add to a genealogy tree), a member tree hint (e.g., a prediction for correcting a node within a genealogy tree of a user account), or a DNA match (e.g., a record indicating a DNA match of a user account to a relative whose information is stored in a genealogical-data system).

In some embodiments, the model-modification system generates, stores, and utilizes RAT-store items. As used herein, the term “RAT-store item” includes or refers to a specific type of content item that is generated by a data expert and/or that includes text descriptions of instructional data or examples of generated outputs for augmenting chain-of-thought for agentic systems and/or large language models. For example, a RAT-store item can include examples of prompts and corresponding responses or results generated by a data expert such that a large language model can analyze the RAT-store item to determine how (e.g., a set of functions for processes) to generate a similar output for a similar prompt. As another example, a RAT-store item can include text descriptions of an instruction set (or a sequence of processes or tasks) that, when performed in the indicated sequence and/or as described in the text of the RAT-store item, produces a result corresponding to a particular prompt and that, when analyzed by a large language model, enables the large language model to generate and execute corresponding computer processes or functions (e.g., processes/functions corresponding to the text-based instructions) to generate such a result for a prompt. In the field of genealogy, a RAT-store item can include a content item generated by a professional genealogist. Example RAT-store items include curated instruction sets specific to particular tasks, employee training documents, help videos, hints, genealogy tree data, curated help databases, research journals, and other expert-generated content items for which quality scores can be assigned and evaluated.

As also used herein, the term “function adapter” refers to computer code executable to perform one or more functions as instructed by a large language model. In particular, a function adapter may refer to computer code (e.g., a process or subroutine) that can adapt a large language model to its task or context by extracting data from relevant databases (e.g., by executing calls to APIs) and/or which can facilitate or execute completion of tasks outside of an agentic framework (e.g., by executing calls to APIs). In some cases, a function adapter is a set of heuristics (e.g., logical rules or programmed subroutines), a neural network (e.g., a large language model), or a combination thereof which can execute tasks, call APIs, and/or extract data for adapting nodes. Additionally, in some embodiments, a function adapter can include or otherwise perform one or more functionalities of a geographic information system that maps specific types of data and/or specific types of data requirements to a specific geographic location. Further, in one or more embodiments, the genealogical-recipe system 100 utilizes function adapters as described in GENEALOGICAL AUTONOMOUS-DECISION FRAMEWORK, U.S. patent application Ser. No. 19/174,550, filed Apr. 9, 2025, which is incorporated herein by reference in its entirety.

Moreover, as used herein, the term the term “RAT replanner” refers to a system component (e.g., a set of software processes or subroutines) that dynamically determines (or identifies) and sequences RAT-store-item processes. In particular, a RAT replanner can include a node within a graph-based agentic framework to: 1) evaluate context of a current RAT process, 2) evaluate RAT-process results or execution outputs to determine and select a subsequent RAT process, and/or 3) determine how to adapt the sequence of processes to perform a particular task or to generate a particular response. For example, a RAT replanner can include a set of heuristics and/or a large-language-model-driven module that: 1) determines and/or selects a subsequent RAT process from a sequence of processes indicated by a RAT-store item, 2) retrieves replanner data from a replanner-data store, and/or 3) reorders or revises an executed RAT process based on intermediate results, user inputs, and/or failure conditions. For example, the RAT replanner may remove previously executed processes of a sequence of processes derived from a RAT-store item to progressively narrow the focus of the model-modification system and to prevent the model-modification system from entering an endless loop. The RAT replanner may thus safeguard against a large language model or the graph-based agentic framework retrieving additional RAT-store items based on the results of a previously executed process of the sequence of processes and adding new processes based on the retrieved additional RAT-store items practically ad infinitum.

Along these lines, as used herein, the term “replanner data” refers to data or information used by a RAT replanner to inform the selection, configuration, and/or execution of one or more processes in a sequence of processes indicated by a RAT-store item. In particular, replanner data can include contextual cues, execution metadata, intermediate outputs, or guidance signals that help determine how the system should proceed following completion of a prior process. For example, replanner data may include text descriptions or examples, task embeddings, tool specifications, output summaries, or content items retrieved from a replanner-data store (e.g., a vector store) to guide a large language model in executing a subsequent process in a sequence of processes indicated by a RAT-store item. Such replanner data may comprise “tips” for more efficiently executing processes of the sequence of processes, which tips may be determined and/or retrieved in view of the growing conversational context as previous processes are executed and results are generated therefrom.

In addition, as used herein, the term “machine learning model” refers to a computer algorithm or a collection of computer algorithms that automatically improve for a particular task through iterative outputs or predictions based on use of data. For example, machine learning model can utilize one or more learning techniques to improve in accuracy and/or effectiveness. Example machine learning models include various types of neural networks, decision trees, support vector machines, linear regression models, and Bayesian networks. In some embodiments, the model-modification system utilizes a large language machine learning model in the form of a neural network.

Relatedly, as used herein, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., search intent and/or content items) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, or a generative adversarial neural network. Upon training as described below, such a neural network may become a large language model that generates responses to prompts by interpreting prompt language, accessing additional data from content items, and executing functions indicated by prompts and/or content items.

Further, as used herein, the term “large language model” refers to a particular type of language-based machine learning model trained to perform computer tasks to generate or identify content items in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning) to interpret and predict text (and other types of content) within a very large data context. For example, a large language model can include parameters trained to generate model outputs (e.g., content items, summaries, or query responses) and/or to identify content items based on various contextual data, including graph information from a knowledge graph and/or historical user account behavior. In some cases, a large language model comprises a GPT model such as, but not limited to, ChatGPT.

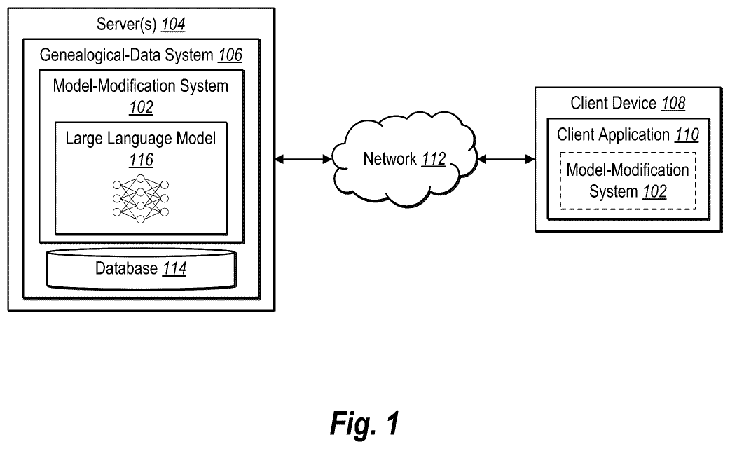

Additional detail regarding the model-modification system will now be provided with reference to the figures. For example, FIG. 1 illustrates a schematic diagram of an example system environment for implementing a model-modification system 102 in accordance with one or more implementations. An overview of the model-modification system 102 is described in relation to FIG. 1. Thereafter, a more detailed description of the components and processes of the model-modification system 102 is provided in relation to the subsequent figures.

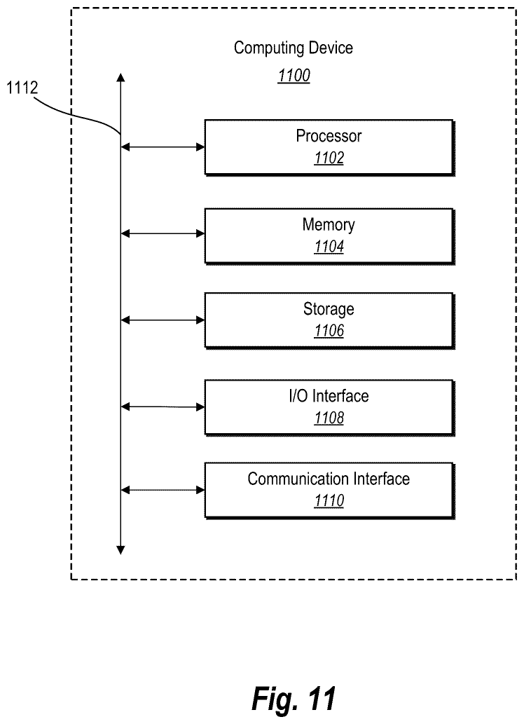

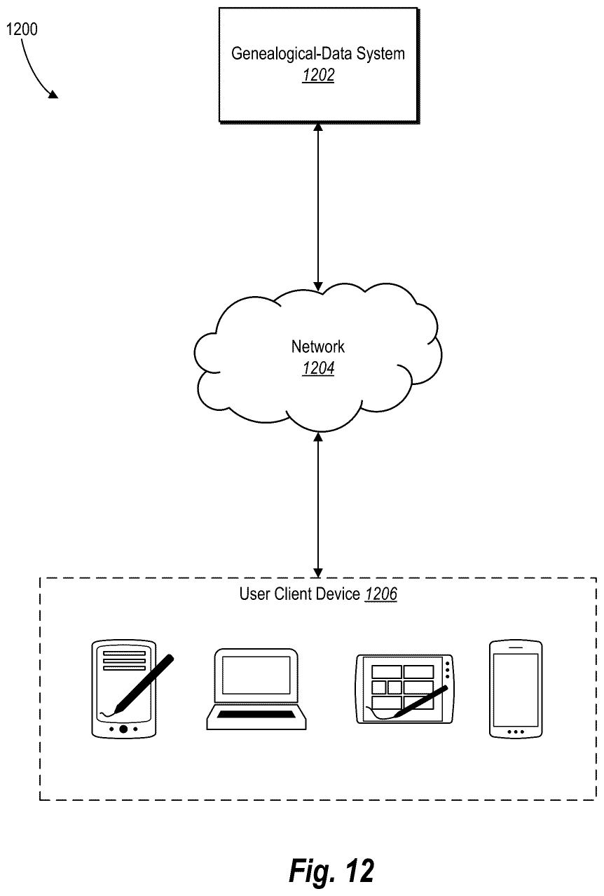

As shown, the environment includes server(s) 104, a client device 108, a database 114, and a network 112. Each of the components of the environment can communicate via the network 112, and the network 112 may be any suitable network over which computing devices can communicate. Example networks are discussed in more detail below in relation to FIGS. 11-12.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 11-12. The client device 108 can communicate with the server(s) 104 and/or the database 114 via the network 112. For example, the client device 108 can receive user input from respective users interacting with the client device 108 (e.g., via the client application 110) to, for instance, search for, access, generate, modify, or share a genealogical content item and/or to interact with a genealogy tree or a content item via a graphical user interface of the genealogical-data system 106. In addition, the model-modification system 102 on the server(s) 104 can receive information relating to various searches for, or interactions with, genealogical content items, and/or user interface elements based on the input received by the client device 108.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a user interface such as a genealogical-content-item-search interface, a genealogy-tree interface, a discover interface for additional genealogical content, or some other graphical user interface, as described herein.

As illustrated in FIG. 1, the example environment also includes the server(s) 104. The server(s) 104 may generate, track, store, process, receive, and transmit electronic data, such as genealogical content items, RAT-store items, prompts, generated responses, and/or interactions with content items. For example, the server(s) 104 may receive data from the client device 108 in the form of a prompt to modify a genealogy database, to modify a genealogy tree, and/or to perform a search for a genealogical content item. In addition, the server(s) 104 can transmit data to the client device 108 in the form of a response (generated by a large language model 116) within a graphical user interface. Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning server, and other types of servers.

As shown in FIG. 1, the server(s) 104 can also include the model-modification system 102 as part of a genealogical-data system 106. The genealogical-data system 106 can communicate with the client device 108 to perform various functions associated with the client application 110 such as managing user accounts, managing genealogical data, managing genealogy trees, managing genealogical content items, and facilitating user interaction with, and sharing of, the genealogy trees and/or genealogical content items. Indeed, the genealogical-data system 106 can include a network-based cloud storage system to manage, store, and maintain genealogical content items and genealogy trees related data user accounts. For instance, the genealogical-data system 106 can utilize genealogical data across various content items and user accounts to generate and maintain a universal genealogy tree that reflects the relatedness or consanguinity between nodes corresponding to all user accounts and other individuals indicated by stored genealogical content items. In some embodiments, the model-modification system 102 and/or the genealogical-data system 106 utilize the database 114 to store and access information such as genealogical content items, genealogy trees, user account data, and/or other information.

As further illustrated in FIG. 1, the genealogical-data system 106 includes a database 114 that stores genealogical content items. In particular, the model-modification system 102 stores the genealogical content items and searches the genealogical content items to generate search results in response to search queries. For instance, the model-modification system 102 receives a search query from the client device 108 and generates, using the large language model 116, a search result that includes one or more records from among the genealogical content items. In some embodiments, the database 114 also includes a RAT store or a repository of RAT-store items that instruct or inform the large language model 116 for performing particular tasks, including accessing and analyzing genealogical content items to generate responses for prompts.

Although FIG. 1 depicts the model-modification system 102 located on the server(s) 104, in some implementations, the model-modification system 102 may be implemented by (e.g., located entirely or in part on) one or more other components of the environment. For example, the model-modification system 102 may be implemented in whole or in part by the client device 108. For example, the client device 108 and/or a third-party system can download all or part of the model-modification system 102 (e.g., the large language model 116 and/or an agentic system) for implementation independent of, or together with, the server(s) 104.

In some implementations, though not illustrated in FIG. 1, the environment may have a different arrangement of components and/or may have a different number or set of components altogether. For example, the client device 108 may communicate directly with the model-modification system 102, bypassing the network 112. As another example, the environment may include multiple client devices, each associated with a different user account. In addition, the environment can include the database 114 located external to the server(s) 104 (e.g., in communication via the network 112) or located on the server(s) 104 and/or on the client device 108.

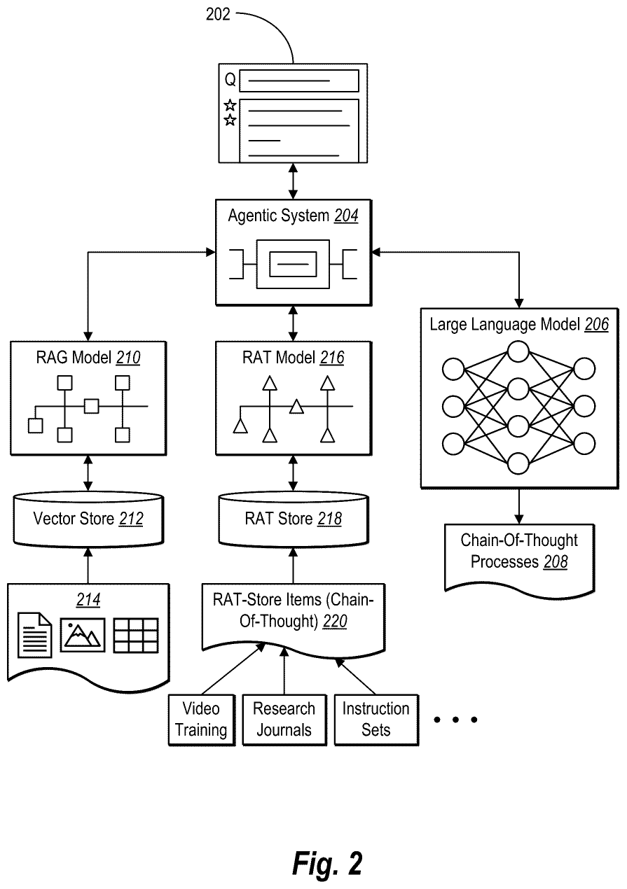

As mentioned above, the model-modification system 102 can utilize a retrieval-augmented-thought approach to generating responses for prompts. In particular, the model-modification system 102 can inform an agentic system and/or an underlying large language model for performing new tasks using a one-shot approach from RAT-store items. As an example of a generated response, the model-modification system 102 can generate genealogical content items, such as record hints or individual names for adding to a genealogy tree or a genealogical database, using a large language model informed by a RAT-store item. FIG. 2 illustrates an example overview of the model-modification system 102 and the interaction of its components, including an agentic system, a large language model, a RAG model, and a RAT model in accordance with one or more embodiments. Additional detail regarding the various acts and processes introduced in relation to FIG. 2 is provided thereafter with reference to subsequent figures.

As illustrated in FIG. 2, the model-modification system 102 utilizes an agentic system 204 to generate and provide responses to prompts via a user interface 202 (e.g., of the client application 110). Indeed, the model-modification system 102 utilizes an agentic system that controls or integrates with a large language model 206 to generate responses to prompts entered via the user interface 202. In generating a response, the large language model 206 executes or generates one or more chain-of-thought processes 208 that include processes or functions executed in a sequence to generate the response. The model-modification system 102 can thus use the agentic system 204 to generate a response through the large language model 206. In addition (or alternatively), the model-modification system 102 can use the agentic system 204 to generate a response using a RAG model 210 and/or a RAT model 216. In some cases, the RAG model 210 and/or the RAT model 216 leverage or implement the large language model 206 in their processes of generating chain-of-thought responses through analyzing stored content.

As just noted, the model-modification system 102 can use the agentic system 204 in one (or a combination) of three modalities to generate a response-using the large language model 206 without additional content retrieval, using the RAG model 210, and/or using the RAT model 216. In some embodiments, the model-modification system 102 prioritizes using the RAG model 210. In these or other embodiments, the model-modification system 102 utilizes the RAG model 210 to access a vector store 212 for analyzing (stored vectors of) content items 214. Indeed, the model-modification system 102 extracts (using an embedding model) vector embeddings from the content items 214 to store in the vector store 212. The model-modification system 102 further compares the vectors in the vector store 212 with a vector extracted from a prompt provided via the user interface 202 (e.g., using the embedding model) to identify one or more content items to use as sources to inform the large language model 206 in generating chain-of-thought processes for a response. The model-modification system 102 determines an accuracy score for a response (or for chain-of-thought processes) generated using the RAG model 210 and proceeds to use the RAT model 216 if the accuracy score for the response fails to satisfy a threshold measure of accuracy (and thus omits and does not provide the generated response in the user interface 202).

In one or more embodiments, the model-modification system 102 prioritizes using the RAT model 216. In these or other embodiments, the model-modification system 102 utilizes the RAT model 216 to access a RAT store 218 for analyzing (stored vectors of) RAT-store items 220. Using one or more of the RAT-store items 220 in the RAT store 218, the model-modification system 102 generates a response by following the execution expressly described or outlined in the RAT-store items 220. In addition, the model-modification system 102 determines an accuracy score for a response generated using the RAT model 216. In some cases, the model-modification system 102 supplements the RAT-based response generation process with additional contextual data by using the RAG model 210 if the accuracy score for the RAT-based response fails to satisfy a threshold measure of accuracy (and thus omits and does not provide the generated RAT-based response in the user interface 202).

As illustrated in FIG. 2, to generate a response using the RAT model 216, the model-modification system 102 generates or otherwise identifies RAT-store items 220. For instance, the model-modification system 102 generates the RAT-store items from expert-generated content items such as training videos, research journals, and curated instruction sets for various chains of thought. The model-modification system 102 further uses an embedding model to extract RAT embeddings from the RAT-store items 220 to store in the RAT store 218. In addition, the model-modification system 102 compares RAT embeddings with a prompt embedding to identify one or more relevant RAT embeddings corresponding to relevant RAT-store items for information chain-of-thought response generation by the large language model 206. As part of generating a response informed by a RAT-store item, the model-modification system 102 can use the agentic system 204 to perform RAG-based steps (as instructed by the RAT-store item) to access and extract data from relevant content items for generating a response. The model-modification system 102 thus augments or provides chain-of-thought processes generated by the agentic system 204 (e.g., via the large language model 206) using the RAT-store items 220.

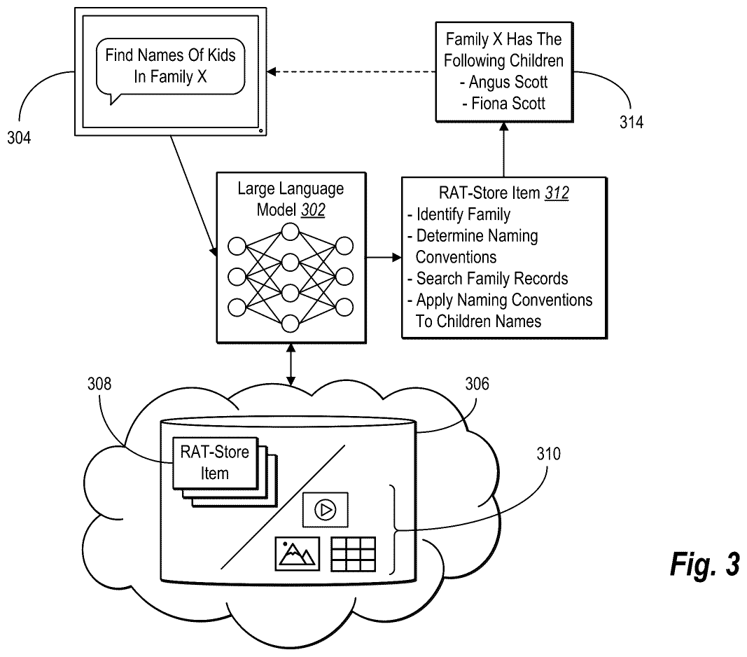

As noted above, in certain embodiments, the model-modification system 102 can use RAT-store items to augment chain-of-thought response generation. In particular, the model-modification system 102 can use an agentic system, including its constituent large language model, to generate a response to a particular query regarding genealogical data. FIG. 3 illustrates an example diagram of using retrieval-augmented thought for a large language model to generate a response in accordance with one or more embodiments.

As illustrated in FIG. 3, the model-modification system 102 utilizes a large language model 302 to analyze prompts and generate responses. In some cases, the model-modification system 102 utilizes the large language model 302 to perform tasks beyond generating responses, such as modifying a genealogical database to include new and/or modified content items, to update one or more genealogy trees with individual names and/or other data associated with nodes on the trees, and/or to generate particular content items corresponding to genealogical data extracted from one or more sources. As shown, the model-modification system 102 utilizes the large language model 302 to analyze a prompt 304.

Indeed, the model-modification system 102 receives the prompt 304 from a client device (e.g., the client device 108). In some cases, the model-modification system 102 receives the prompt 304 in the form of digital text requesting performance of a particular task, such as generating a response to a query or generating a content item as instructed by language in the prompt 304. In these or other cases, the prompt 304 includes additional prompt data, such as one or more attached content items to inform text included in the prompt 304 and which is interpretable by the large language model 302 as part of analyzing the prompt 304 to generate a response.

In some embodiments, the model-modification system 102 utilizes the large language model 302 to analyze the prompt 304 in a RAT-first paradigm. To elaborate, the model-modification system 102 analyzes (via the large language model 302) the prompt 304 to first identify a RAT-store item for generating a response before proceeding to RAG-based retrieval of content items for response generation. Indeed, the model-modification system 102 can (using the large language model 302) search a RAT store 308 within a database 306 (e.g., the database 114) to identify a RAT-store item corresponding to the prompt 304. The model-modification system 102 can further analyze (via the large language model 302) the RAT-store item to learn processes or functions for generating a response corresponding to the prompt 304. As part of such processes or functions, the RAT-store item can instruct the large language model 302 to perform RAG-based retrieval and augmentation of content items 310 within the database 306.

In one or more embodiments, the model-modification system 102 utilizes the large language model 302 to analyze the prompt 304 in a RAG-first paradigm. To elaborate, the model-modification system 102 analyzes (via the large language model 302) the prompt 304 using a RAG approach to identify and retrieve content items 310 from a database 306 for generating a response. If the model-modification system 102 determines (using the large language model 302) that no relevant content items are in the database 306 and/or that the prompt 304 is requesting a task (e.g., a generated response) that the large language model 302 cannot perform with at least a threshold measure of accuracy or confidence, then the model-modification system 102 switches to (or supplements retrieved RAG data with) a RAT approach. Accordingly, the model-modification system 102 searches (using the large language model 302) the RAT store 308 to identify a RAT-store item corresponding to the prompt 304.

To identify a RAT-store item corresponding to the prompt 304, the model-modification system 102 analyzes (via the large language model 302) the prompt 304 to determine a topic or a task and/or to extract keywords for searching a RAT store 308. Indeed, the model-modification system 102 determines the topic or the task of the prompt 304 using the large language model 302 to interpret the language of the prompt 304. Similarly, the model-modification system 102 uses the large language model 302 to determine topics or tasks associated with RAT-store items in the RAT store 308 and compares the topics or tasks to identify relevant RAT-store items. The model-modification system 102 thus identifies a relevant RAT-store item as one with a topic or task with a threshold semantic similarity according to lexical meaning, Jaccard similarity, and/or cosine similarity (or some other distance metric) of topic/task embeddings in an embedding space.

As part of identifying a RAT-store item for the prompt 304, in some embodiments, the model-modification system 102 uses the large language model 302 or a separate embedding model to extract embeddings (e.g., latent vector representations) of RAT-store items in the RAT store 308. In addition, the model-modification system 102 extracts (e.g., using the large language model 302 or a separate embedding model) a prompt embedding from the prompt 304 to compare with RAT store embeddings extracted from RAT-store items. The model-modification system 102 thus identifies a relevant RAT-store item for the prompt 304 as one with a RAT store embedding within a threshold distance of the prompt embedding in the latent embedding space.

As further illustrated in FIG. 3, the model-modification system 102 thus utilizes the large language model 302 to identify a RAT-store item 312 corresponding to the prompt 304. As shown, the RAT-store item 312 is an expert-generated instruction set that includes text descriptions of processes or functions performable by the large language model 302 to generate a response 314. Accordingly, the large language model 302 analyzes the RAT-store item 312 and executes the processes or functions described to generate the response 314.

As shown, the model-modification system 102 thus generates the response 314 which indicates that “Family X has the following children: Angus Scott and Fiona Scott.” To generate the response 314, the model-modification system 102 uses the large language model 302 to follow the described steps in the RAT-store item 312, including: 1) identifying Family X, 2) determining naming conventions (e.g., based on a country or ethnicity associated with Family X, an analysis of naming conventions of known family members and other children in Family X, as well as different time periods associated with different children which could impact naming conventions), 3) searching family records to identify children names (e.g., in databases known to store records for Family X and/or in databases associated with government bodies or other entities that store data for individuals from the same country or region as Family X), and 4) applying the naming conventions identified children names. The RAT-store item 312 can also include additional text instructions describing the sequence of executing the processes and/or various data sources or applications to use in executing the processes. The model-modification system 102 thus generates the response 314 using the large language model 302 and/or various function adapters to execute the various steps indicated in the RAT-store item 312 (in the indicated order). The model-modification system 102 can further provide the response 314 for display on the client device in response to the prompt 304.

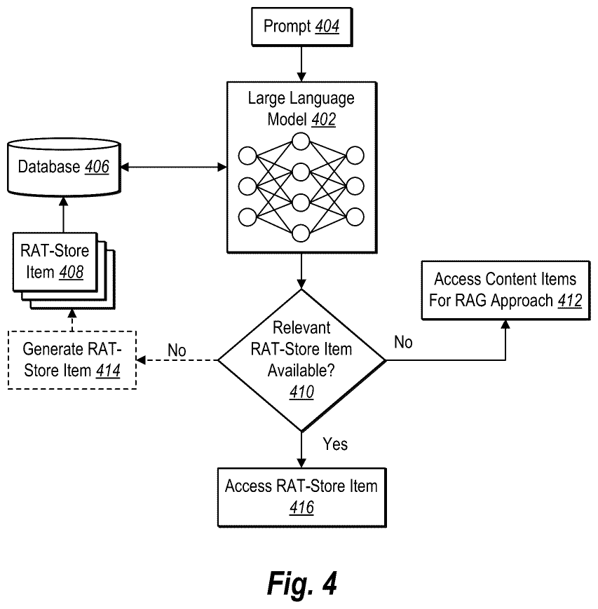

As noted above, in certain described embodiments, the model-modification system 102 utilizes a large language model to analyze RAT-store items for performing tasks. In particular, the model-modification system 102 stores and accesses RAT-store items in a RAT store or a RAT database that includes a repository of RAT-store items. FIG. 4 illustrates an example diagram for storing and utilizing RAT-store items in accordance with one or more embodiments.

As illustrated in FIG. 4, the model-modification system 102 accesses a database 406 that includes RAT-store items, such as the RAT-store item 408. More particularly, the database 406 can be a RAT store (e.g., storing extracted vectors of RAT-store items) or a repository of RAT-store items. In some cases, the model-modification system 102 generates or receives RAT-store items to include or store in the database 406. For instance, the RAT-store items can include expert-generated instructions sets, examples or descriptions of generated data mappable to responses, and/or synthesized RAT data such as instructions or examples taken from other content items (e.g., content items which can be given a quality score to determine their quality or reliability).

As just mentioned, the RAT-store item 408 can include an expert-generated instruction set. As shown, the model-modification system 102 receives the RAT-store item 408 in the form of an expert-generated instruction set for how to perform a particular task or generate a particular response. In some cases, the RAT-store item 408 is generated by a professional genealogist and includes text descriptions of an ordered sequence of processes or functions that, when performed, accomplish a task or generate a response. For example, the RAT-store item 408 can include text descriptions of processes that are interpretable by a large language model 402 to convert the text descriptions into executable computer code and/or computer functions for generating a response. In some cases, the computer code is interpretable or executable by the large language model 402 and/or other computer applications or systems, such as genealogical modeling systems, DNA analysis systems, word processing application, or other computer applications.

As noted, the RAT-store item 408 can include examples or descriptions of generated data mappable to responses. To elaborate, the model-modification system 102 can receive the RAT-store item 408 as a content item that includes example data generated by an expert. For instance, the RAT-store item 408 can be a research journal compiled by one or more professional genealogists on a particular topic. In some cases, a research journal includes descriptions of problem statements for difficult genealogical information to locate or generate, along with text descriptions of test methods and success events defining solutions to the problem statements. Other example data for the RAT-store item 408 can come from expert-generated answers to user account questions (e.g., on an FAQ page or a Q&A page), employee training data, a central expert-generated genealogy includes nodes across the genealogical-data system 106, and an expert-generated family search wiki.

As mentioned above, the RAT-store item 408 can include synthesized RAT data such as instructions or examples taken from other content items. To elaborate, the model-modification system 102 can generate or synthesize the RAT-store item 408 from other content items. For example, the model-modification system 102 can identify content items relating to commonly shared topics or tasks and can generate the RAT-store item 408 by extracting and synthesizing data from the related content items. In some cases, synthesizing the RAT-store item 408 involves generating text descriptions of instructions for generating a particular response or a particular data point by interpreting (using the large language model 402) and synthesizing processes or functions into text descriptions in an ordered sequence. The model-modification system 102 can thus generate hundreds or thousands of RAT-store items to store in the database 406, where each RAT-store item includes interpretable data (e.g., instructions or examples) for generating a particular response in a particular format by analyzing a particular set of content items.

In one or more embodiments, the model-modification system 102 stores the RAT-store item 408 (and other RAT-store items) in the database 406. In these or other embodiments, the model-modification system 102 stores an embedding of the RAT-store item 408 in the database. For example, the model-modification system 102 utilizes an embedding model (e.g., an autoencoder or some other encoder-based neural network architecture) to extract or encode a latent vector representing the RAT-store item 408. The model-modification system 102 thus stores the RAT store embedding in the database 406 for comparing with prompt embeddings (extracted from prompts) to identify relevant RAT-store items.

As also illustrated in FIG. 4, the model-modification system 102 utilizes a large language model 402 to analyze a prompt 404. In particular, the model-modification system 102 receives the prompt 404 from a client device requesting performance of a particular task (e.g., modifying a genealogical database or a genealogy tree) or generation of a particular response (e.g., a content item or data to include in a content item).

As shown, the model-modification system 102 utilizes the large language model 402 to analyze the prompt 404 to determine whether the large language model 402 can generate a response to the prompt 404. More particularly, the model-modification system 102 analyzes the prompt 404 to determine whether the already learned parameters of the large language model 402 are tuned for generating a response to the prompt 404. In some cases, the model-modification system 102 determines an accuracy score or a confidence score for (responses generated by) the large language model 402 in relation to the prompt 404. Indeed, the large language model 402 can generate a sample response to the prompt 404 using its already learned parameters and can generate a confidence score corresponding to or accompanying the sample response. In some cases, the model-modification system 102 uses a separate evaluation model to determine an accuracy score or a confidence score for a sample response of the large language model 402.

In some embodiments, upon determining that the large language model 402 cannot (with at least a threshold measure of accuracy or confidence) generate a response for the prompt 404 using the current state of its parameters, the model-modification system 102 determines to access the database 406 for the repository of RAT-store items. For example, the model-modification system 102 determines a topic or a task associated with the prompt 404 and searches the database 406 for a corresponding RAT-store item. In some cases, the model-modification system 102 uses the large language model 402 to extract a prompt embedding to compare with RAT store embeddings in the database 406. The model-modification system 102 identifies a relevant RAT-store item as one whose embedding is within a threshold distance of the prompt embedding (or one with an associated task having at least a threshold Jaccard similarity or lexical similarity to the task of the prompt 404).

As illustrated in FIG. 4, the performs an act 410 to determine whether a relevant RAT-store item is available. To elaborate, (upon determining that the large language model 402 is not fit to generate response to the prompt 404) the model-modification system 102 analyzes the repository of RAT-store items in the database 406 to identify one whose embedding is within a threshold similarity of a prompt embedding of the prompt 404. If the model-modification system 102 identifies multiple RAT store embeddings within a threshold distance or a threshold similarity, the model-modification system 102 selects a most similar RAT-store item. In some cases, the model-modification system 102 can extract and combine expert data from multiple relevant RAT-store items. For example, if the model-modification system 102 determines that one RAT-store item includes a set of instructions (or example data) that, when combined with another set of instructions (or example data) from another RAT-store item, the model-modification system 102 can combine the instructions into a hybrid RAT-store item. The model-modification system 102 further performs an act 416 to access a relevant RAT-store item (which can include a hybrid RAT-store item) to inform the large language model 402 on generating a response for the prompt 404.

As further illustrated in FIG. 4, the model-modification system 102 can determine that no RAT-store item is within a threshold similarity of the prompt 404. In such cases, the model-modification system 102 can perform an act 412 to implement a RAG approach. For example, the model-modification system 102 can search for and access content items from a database or a repository of content items. In some cases, the model-modification system 102 determines or identifies content items corresponding to the prompt 404 by comparing content item embeddings with the prompt embedding. Indeed, the model-modification system 102 can extract or encode content item embeddings to store in an embedding database for comparing (using the large language model 402) with extracted prompt embeddings. Upon identifying one or more relevant content items for the prompt 404, the model-modification system 102 can further use the large language model 402 to generate a response informed by the relevant content items (e.g., using portions of content extracted from the relevant content items).

In one or more embodiments, based on determining that no relevant RAT-store item is available, the model-modification system 102 can further perform an act 414 to generate a new RAT-store item. In some cases, the model-modification system 102 can generate and provide a notification that no relevant RAT-store item is available in the database 406 to inform experts to generate and upload a new RAT-store item. In other cases, the model-modification system 102 can generate a new RAT-store item autonomously (e.g., without intervention or input from experts or other user accounts).

To elaborate, the model-modification system 102 can use the large language model 402 to (after receiving the prompt 404 and determining that no relevant RAT-store item is stored in the database 406) generate a new RAT-store item specifically customized for the prompt 404. For example, the model-modification system 102 can use the large language model 402 to identify relevant content items and can determine a structure for a new RAT-store item (e.g., as a sequence of instructions or a set of examples) based on existing RAT-store items. Indeed, the model-modification system 102 can determine a format of a response for the prompt 404 and can identify RAT-store items that lead to large language models (e.g., the large language model 402) generating responses in a similar (or the same) format. The model-modification system 102 can further use the structure or rubric of an identified RAT-store item (e.g., the RAT-store item 408) and can populate the structure with content from relevant content items to generate a new RAT-store item corresponding to the prompt 404. The model-modification system 102 can further store the new RAT-store item in the database 406 for use in response to future prompts.

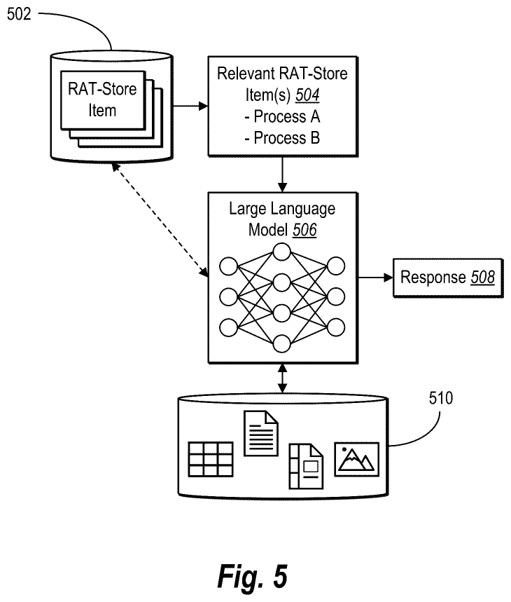

As mentioned above, in certain described embodiments, the model-modification system 102 generates a response for a prompt using a RAT-store item to inform a large language model. In particular, the model-modification system 102 identifies a relevant RAT-store item and uses a large language model to execute functions or processes as informed by the relevant RAT-store item. FIG. 5 illustrates an example diagram for generating a response using a RAT-store item in accordance with one or more embodiments.

As illustrated in FIG. 5, the model-modification system 102 accesses and analyzes a repository of RAT-store items 502. In addition, the model-modification system 102 identifies and retrieves one or more relevant RAT-store item(s) 504 corresponding to a prompt. In some cases, the model-modification system 102 identifies multiple RAT-store items corresponding to a prompt and combines instructions and/or examples from them into a hybrid RAT-store item. Indeed, the model-modification system 102 can use a large language model 506 to identify and/or combine the one or more RAT-store item(s) 504.

As further illustrated in FIG. 5, the model-modification system 102 uses the large language model 506 to generate a response 508 to a prompt. To elaborate, the model-modification system 102 uses the large language model 506 to analyze text descriptions of instructions and/or examples in the one or more relevant RAT-store item(s) 504. The model-modification system 102 further uses the large language model 506 to execute functions or processes defined by the text descriptions. Indeed, the large language model 506 can interpret the text descriptions to generate computer processes or subroutines that, when executed, generate a result defined by a text description of an instruction or an example.

In some cases, the model-modification system 102 uses the large language model 302 to execute one or more functions from text descriptions. In these or other cases, the model-modification system 102 uses other processors, systems or applications to execute functions or processes (generated from text descriptions) to generate the response 508. Indeed, the model-modification system 102 can use the large language model 506 to identify processes (among the text descriptions of the one or more RAT-store item(s) 504) that the large language model 506 cannot execute and/or that specifically calls for (or is compatible with) another computer application or system to execute. For such processes, the model-modification system 102 can further use the large language model 506 to generate (from the text descriptions of the processes) executable computer code compatible with the identified system or application, such as a particular genealogical modeling software, a word processing application, or some other computer application (or system). The model-modification system 102 can thus use the large language model 506 to execute one subset of processes in the one or more RAT-store item(s) 504 and can use one or more other applications to execute other subsets of processes. The model-modification system 102 can further use the large language model 506 to combine the outputs generated data from the various executed processes (at respective applications and/or the large language model 506) into the response 508.

As part of generating the response 508, the model-modification system 102 can access a database 510. Indeed, the model-modification system 102 can access the database 510 that stores or houses a repository of content items. The model-modification system 102 can thus use the large language model 506 in a hybrid RAT-RAG approach (e.g., by accessing RAG-store items as informed or instructed by the relevant RAT-store item(s) 504) to identify and extract data from content items corresponding to a prompt. Similarly, the model-modification system 102 can implement additional RAG-type analysis of the stored content items to identify those that correspond to the one or more RAT-store item(s) 504. For instance, the model-modification system 102 can use the large language model 506 to identify content items from the database 510 corresponding to the one or more RAT-store item(s) 504. Indeed, the large language model 506 can compare RAT store embeddings with content item embeddings and can select content items whose embeddings are within a threshold distance or similarity to the RAT store embedding(s). The model-modification system 102 can further extract and use (via the large language model 506) content from selected content items in the database 510 to generate the response 508.

As a specific example of generating the response 508, the model-modification system 102 can receive a prompt of “Find names of children in by family.” Based on this prompt, the model-modification system 102 determines that the user account has a family with members of Scottish descent. Accordingly, the model-modification system 102 further determines that the large language model 506 does not know how to (with a threshold accuracy) research Scottish genealogy. Based on this determination, the model-modification system 102 searches the repository of RAT-store items 502 to identify one or more RAT-store item(s) 504 that include text descriptions of performing Scottish genealogy research. For instance, the model-modification system 102 identifies a digital slide presentation created by an expert genealogist that includes examples and text descriptions of how to research Scottish family names, including which databases to access, how to access the databases, how Scottish naming conventions work for male children and female children, and how naming conventions have evolved over time. The model-modification system 102 thus uses the RAT-store item to inform the large language model 506 on how to research Scottish genealogy. Accordingly, the large language model 506 generates and executes processes from the text descriptions in the one or more RAT-store item(s) 504 to generate the response 508 which names children in the family (e.g., by locating the proper databases, identifying relevant content items in the databases, extracting data relating to children in the family, and applying learned naming conventions).

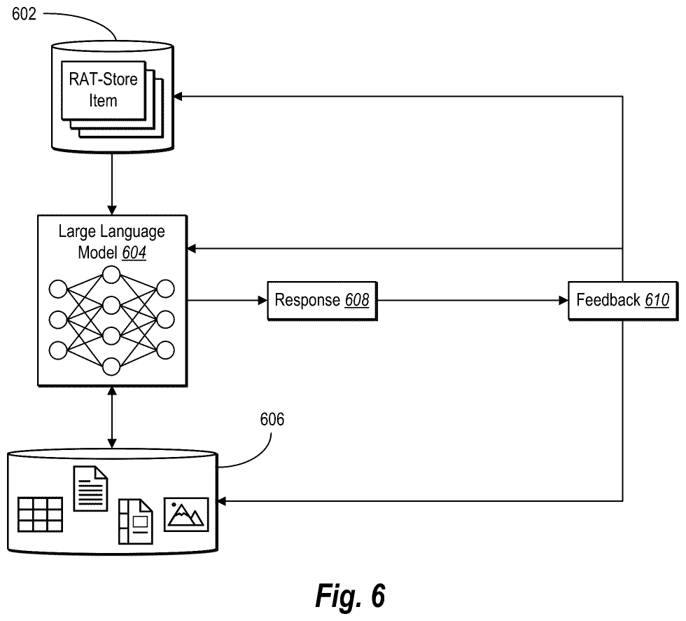

In one or more embodiments, the model-modification system 102 can update or modify parameters of a large language model and/or other components or models. In particular, the model-modification system 102 can include embedding models, a large language model, and various databases for embeddings, RAT-store items, and other content items that can be updated to improve accuracy in response generation. FIG. 6 illustrates an example diagram of modifying parameters within a model-modification system to improve response accuracy in accordance with one or more embodiments.

As illustrated in FIG. 6, the model-modification system 102 can generate a response 608. Based on the response 608, the model-modification system 102 can receive feedback 610 from a client device and/or an administrator device. The feedback 610 can be in the form of an express indication of approval or disapproval of the response 608 (e.g., thumbs up/down), a score for the response (e.g., from 1 to 10), or a text description of approval or disapproval. In some cases, the feedback 610 can be implied or implicit feedback based on monitoring use or disuse of the response 608. Indeed, the model-modification system 102 can monitor the response 608 to determine if, when, and how it is used to indicate the feedback 610.

The model-modification system 102 can further update parameters of the large language model 604, the repository of RAT-store items 602, the database of content items 606, and/or embedding models that extract embedding models from the RAT-store items and the content items. In some cases, the model-modification system 102 can modify individual text descriptions (or corresponding processes or functions) of a RAT-store item used to generate the response 608. The model-modification system 102 can thus improve the performance of the overall system in generating responses to future prompts. Indeed, the model-modification system 102 can modify parameters to generate responses differently based on negative feedback or disuse of the response 608.

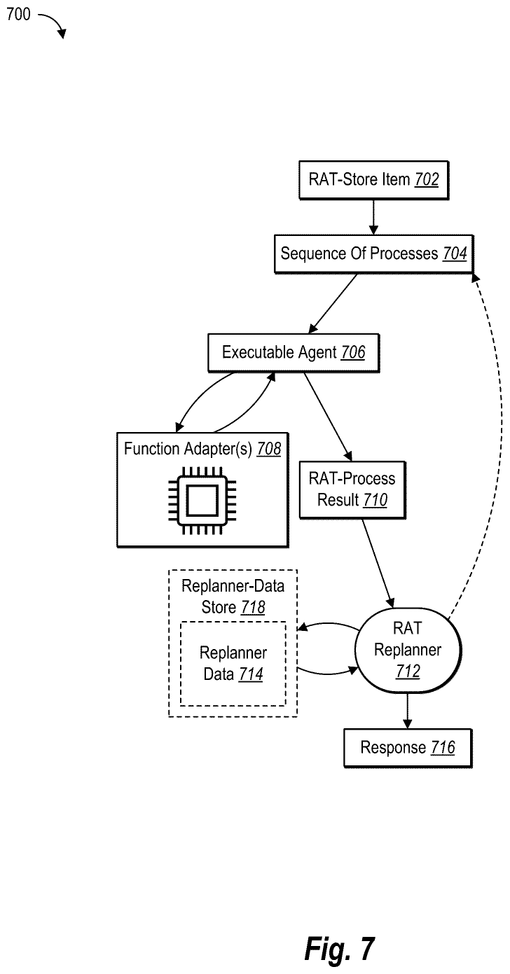

As expressed above, the model-modification system 102 may determine and execute (or perform) a sequence of processes indicated by a RAT-store item. In particular, the model-modification system 102 may utilize a graph-based agentic framework made up of nodes that call or correspond to respective functions in carrying out the sequential performance of instructions in a RAT-store item. FIG. 7 illustrates an example diagram of a graph-based agentic framework associated with (or utilized by) the model-modification system 102 in accordance with one or more embodiments.

As illustrated in FIG. 7, the model-modification system 102 includes and/or utilizes a graph-based agentic framework 700. For instance, the graph-based agentic framework 700 may correspond to or include a LangGraph framework, though the disclosure is not limited thereto and may incorporate or cooperate with any suitable modality or framework. To elaborate, the graph-based agentic framework 700 may enable the creation of agentic workflows by allowing large language models, tools (e.g., function adapters), memory systems, and/or decision logic to operate as interconnected nodes that share and update a persistent state across execution cycles. For instance, the graph-based agentic framework 700 may include a plurality of nodes, such as an executable agent 706, one or more function adapters 708, a RAT replanner 712, and/or one or more large language models. Each node within the graph-based agentic framework 700 may represent a distinct functional unit that can be invoked conditionally based on an evolving state. The directed edges between nodes may define the permissible transitions or data flow, allowing the system to dynamically branch, iterate, and/or pause execution depending on the outcome of intermediate computations.

As also illustrated in FIG. 7, the model-modification system 102 can leverage the graph-based agentic framework 700 to determine a sequence of processes 704 indicated by a RAT-store item 702 in response to a user query. Specifically, the model-modification system 102 may determine the sequence of processes 704 from the RAT-store item 702 based on text descriptions of an instruction set or an example set included in the RAT-store item 702 determined to be pertinent to the user query. In some cases, the model-modification system 102 may utilize the sequence of processes 704 to inform a large language model to perform a particular task or to generate a particular response (e.g., a response 716). The sequence of processes 704 may include one process or a plurality of processes. While a user query and a response 716 thereto are described, it will be appreciated that the graph-based agentic framework 700 is not limited to generating responses to user queries but may be applied as suitable to any task.

The graph-based agentic framework 700 advantageously brings to bear numerous improvements over existing agentic systems. The graph-based agentic framework 700 advantageously includes a replanner node “in the loop” and/or in cooperation with subgraphs for executing processes identified by an initial planner node, allowing the graph-based agentic framework 700 to dynamically adapt to the changing context of the sequence of processes as results are determined, tasks are performed, and/or context is grown. This allows the graph-based agentic framework 700 to iteratively revise the sequence of processes identified by the initial planner node responsive to context-specific circumstances. For example, more-granular tips and context may be retrieved via vector-database search based on the growing context of the graph-based agentic framework 700 after execution of each process of the sequence of processes, improving accuracy and efficiency of the graph-based agentic framework 700 in generating responses to queries.

Further, the replanner node may be configured to remove (or ignore, only looking at current processes) previously executed processes from the sequence of processes determined initially by the planner, thereby focusing the attention of the graph-based agentic framework 700 and correspondingly improving resource economies. In some embodiments, removing previously executed processes may include focusing the attention of the graph-based agentic framework 700 on a current process of the sequence of processes 704 without modifying the sequence of processes 704 and/or modifying the sequence of processes 704 to remove the previously executed processes. The replanner node may be further configured in embodiments to retrieve additional and/or more-granular context via a vector-database search with the execution of subsequent processes of the sequence of processes. For instance, with one or more of the processes of the sequence of processes, the replanner node may execute a vector-database search to identify additional context-specific sub-processes, e.g. replanner data or “tips,” specific to the process next to be executed and based on results from the previously executed process(es). This improves performance and efficiency of the graph-based agentic framework 700 as the retrieved sub-processes yield better results given the more-focused context for tools such as the large language model.

Additionally, as illustrated in FIG. 7, the model-modification system 102 utilizes an executable agent 706 of the graph-based agentic framework 700 to determine one or more function adapters 708 for executing a particular RAT process of the sequence of processes 704. In particular, the model-modification system 102 may utilize the executable agent 706 to generate an LLM prompt or code to instruct a large language model to determine (or select) the one or more function adapters 708 from among a plurality of candidate executable function adapters for executing the particular RAT process of the sequence of processes 704. In some cases, the LLM prompt or code may include a prompt entered via a user interface (e.g., via the user interface 202) and/or a system prompt (e.g., informing the large language model of an objective and various rules to follow).

It has been surprisingly found that existing agents and agentic frameworks struggle to properly select a function adapter responsive to a process of the sequence of processes when, for example, the candidate function adapters are not directly related to the determined process of the sequence of processes and/or when too many candidate function adapters are determined to be plausibly related to the corresponding process of the sequence of processes. It has been found that when this occurs, agentic frameworks are apt to consolidate a process for which too many or too few candidate function adapters have been identified with an adjacent process, but this short circuits the identified step-by-step process identified by the planner node. The model-modification system 102 is advantageously configured to utilize the graph-based agentic framework 700 to explicitly enforce separation of processes identified in the sequence of processes and loop over each of the processes of the sequence of processes. Further, in embodiments, where too many candidate function adapters are identified for a particular process, the model-modification system 102 may utilize the large language model or other modality to generate a ranking of the candidate function adapters to filter the function adapters, thereby improving efficiency and accuracy by reducing the number of tool calls while also reducing noise in the generated results.

In one or more embodiments, the model-modification system 102 utilizes the large language model to determine (or select) the one or more function adapters 708 from among the plurality of candidate function adapters. In particular, in response to detecting (or receiving) the LLM prompt or code from the executable agent 706, the large language model determines the one or more function adapters 708 according to the particular RAT process of the sequence of processes 704 defined by the RAT-store item 702 and/or according to the LLM prompt or code.

As an example, if the particular RAT process relates to obtaining data via search and retrieval (e.g., of content items), the large language model may determine (or identify) a search function adapter. As another example, if the particular RAT process relates to obtaining data from a genealogy tree, the large language model may determine (or identify) a genealogical-tree function adapter. As another example, if the particular RAT process relates to obtaining data from searching documentation for information, the large language model may determine (or identify) a documentation function adapter. As yet another example, if the particular RAT process relates to obtaining data from genetic data, the large language model may determine (or identify) a genetic-data function adapter.

As further illustrated in FIG. 7, the model-modification system 102 determines (or identifies, obtains, or generates) a RAT-process result 710 for the particular RAT process of the sequence of processes 704. For instance, the model-modification system 102 may execute the particular RAT process utilizing the one or more function adapters 708 to determine the RAT-process result 710. For instance, the RAT-process result 710 may include a content item, data from a genealogy tree, information (e.g., associated with a document), genetic data, and/or other forms of data.

As shown in FIG. 7, the model-modification system 102 utilizes a RAT replanner 712 of the graph-based agentic framework 700 to determine (or identify) and/or select a subsequent RAT process from the sequence of processes 704 to execute. For instance, upon executing the particular RAT process as described above, the model-modification system 102 may utilize the RAT replanner 712 to determine the subsequent RAT process and again follow the steps described above to determine (or identify, obtain, or generate) a subsequent RAT-process result for the subsequent RAT process. For instance, the model-modification system 102 may utilize the executable agent 706 and the large language model to determine one or more function adapters 708 for executing the subsequent RAT process, and may utilize the one or more function adapters 708 to determine (or identify, obtain, or generate) the subsequent RAT-process result. In at least one embodiment, the model-modification system 102 may utilize the RAT replanner 712 to iteratively perform these steps in a replan loop for a plurality of subsequent RAT processes of the sequence of processes 704. Additionally, the model-modification system 102 may execute or perform each RAT process of the sequence of processes 704 in a sequential manner, where each process in the sequence of processes may be executed one at a time or in isolation of other RAT processes (e.g., to avoid overlapping RAT processes).

As also shown in FIG. 7, the model-modification system 102 may utilize the RAT replanner 712 to determine (or identify or obtain) replanner data 714 to utilize in (or to inform the execution of) one or more subsequent RAT processes of the sequence of processes 704. Specifically, the model-modification system 102 may determine, from a replanner-data store 718 (e.g., a vector store), the replanner data 714 (e.g., in the form of another RAT-store item or a specialized type of supplemental RAT data) by utilizing the RAT replanner 712 to determine contextual data for informing execution of the one or more subsequent RAT processes by the large language model. For instance, the model-modification system 102 may determine the replanner data 714 for the subsequent RAT process after execution (e.g., after determining the RAT-process result 710) of the particular RAT process as described above.

Said replanner data 714 for said subsequent RAT processes may be determined based on one or both of the retrieved replanner-data-store item and the growing persistent context of the model-modification system 102, e.g., based on the previously generated result(s) 710. In embodiments, the replanner data 714 may include RAT—and/or RAG-store items retrieved specific to discrete and/or granular tasks associated with a discrete process. That is, a four-step process 704 determined from a pertinent RAT-store item 702 retrieved in response to a user query “Compare hints for Mary Smith in my tree,” may include discrete processes including 1) gather hints, 2) cross-compare each pair of hints for consistency and conflict, 3) perform cross-cluster analysis, and 4) report the analysis. For each of the four steps of the process 704, discrete “tips” may be retrieved from the replanner-data store 718, which may overlap with the RAT-data store. That is, the graph-based agentic framework may search the replanner-data store 718 for resources specific to one or more of the identified processes in the sequence of processes 704. For example, specifically for the second step, retrieved tips may include “Determine whether to group or distinguish each hint pair by assessing names, proximity of key dates, geographic relationships, and overlapping family relationships” and “Track hint IDs for reference throughout the analysis.” That graph-based agentic framework and/or large language model may use the retrieved tips to better execute the step/process of the sequence of processes 704.

As an example, the model-modification system 102 may determine that that the sequence of processes 704 indicated by the RAT-store item 702 includes four processes. The model-modification system 102 may utilize the large language model to execute a first RAT process (as described above) to determine the RAT-process result 710. Upon executing the first RAT process, the model-modification system 102 may utilize the RAT replanner 712 to determine a second RAT process to execute from among the sequence of processes 704. Also upon executing the first RAT process, the model-modification system 102 may determine the replanner data 714 by utilizing the RAT replanner 712 to determine contextual data for informing execution of the second RAT process by the large language model. The model-modification system 102 may then utilize the large language model and the additional contextual data provided by the replanner data 714 to execute the second RAT process to determine a second RAT-process result. The model-modification system 102 may iteratively repeat this process for the exemplary four processes of the sequence of processes 704 (or until generating the response 716 with at least a threshold confidence of answering a query or performing a requested task).

As further shown in FIG. 7, the model-modification system 102 generates a response 716 utilizing the large language model. In particular, the model-modification system 102 generates the response 716 based on the RAT-process results (e.g., the RAT-process result 710) obtained by iteratively and sequentially executing each RAT process of the sequence of processes 704. In some instances, the model-modification system 102 may generate the response 716 as described above (e.g., in relation to FIG. 5). Additionally or alternatively, the model-modification system 102 may perform one or more particular tasks beyond generating the response 716 based on the RAT-process results (e.g., the RAT-process result 710) obtained by iteratively and sequentially executing each RAT process of the sequence of processes 704. For example, the model-modification system 102 may perform tasks as described above (e.g., in relation to FIG. 3).

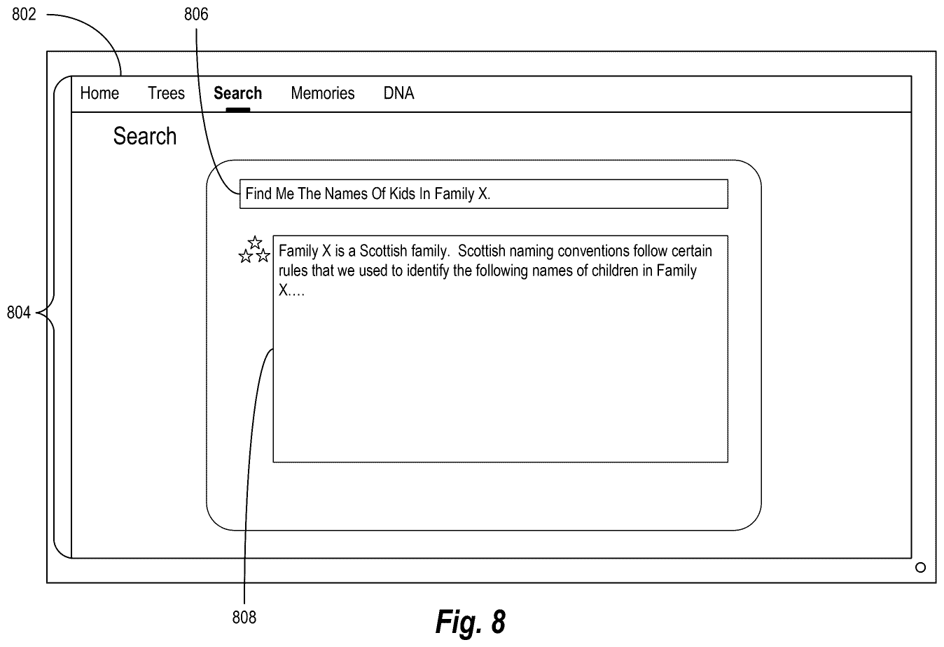

As mentioned above, in certain described embodiments, the model-modification system 102 can generate and provide responses for display on client devices. In particular, the model-modification system 102 can provide a search interface (or an interface for some other function) for receiving prompts and generating responses using RAT-store items. FIG. 8 illustrates an example interface for generating responses using a model-modification system in accordance with one or more embodiments.

As illustrated in FIG. 8, the client device 802 displays or presents a search interface 804. Indeed, the model-modification system 102 generates and provides the search interface 804 for display in a client device 802. Through the search interface 804, the model-modification system 102 receives a prompt 806 (e.g., “Find Me The Names Of Kids In Family X”). For instance, the prompt 806 may be a user prompt (e.g., a user query) or a system prompt (e.g., a system query, as determined by the model-modification system 102). In one or more embodiments, the prompt 806 may be instructions to perform one or more tasks (e.g., as provided by a user or by the model-modification system 102).

In response to the prompt 806, the model-modification system 102 generates the response 808 to display within the search interface 804. For instance, the model-modification system 102 generates the response 808 using a large language model to access and process a RAT-store item as described herein. In one or more embodiments, the model-modification system 102 may generate the response 808 to provide an answer to the prompt 806. As an example, in response to receiving a user query or a system query, the model-modification system 102 may generate an answer to the query (e.g., “Family X is a Scottish family. Scottish naming conventions follow certain rules that we used to identify the following names of children in Family X . . . ”). In some cases, the response 808 may additionally or alternatively include one or more content items.

In the same or other embodiments, the response 808 may provide information regarding one or more processes or steps taken in performing one or more tasks. For example, in response to receiving the prompt 806 that instructs modifying a genealogical database or a genealogy tree, the model-modification system 102 may generate the response 808 to include information that incudes how the genealogical database or the genealogy tree was modified and what processes or steps were taken to perform that modification (e.g., which may include the reasoning behind the particular modification). Additionally or alternatively, the model-modification system 102 may generate the response 808 to provide, for display in the search interface 804, a digital representation of the modified genealogical database or the modified genealogy tree.

The components of the model-modification system 102 can include software, hardware, or both. For example, the components of the model-modification system 102 can include one or more instructions stored on a computer-readable storage medium and executable by processors of one or more computing devices. When executed by one or more processors, the computer-executable instructions of the model-modification system 102 can cause a computing device to perform the methods described herein. Alternatively, the components of the model-modification system 102 can comprise hardware, such as a special purpose processing device to perform a certain function or group of functions. Additionally or alternatively, the components of the model-modification system 102 can include a combination of computer-executable instructions and hardware.

Furthermore, the components of the model-modification system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the model-modification system 102 may be implemented as part of a stand-alone application on a personal computing device or a mobile device.

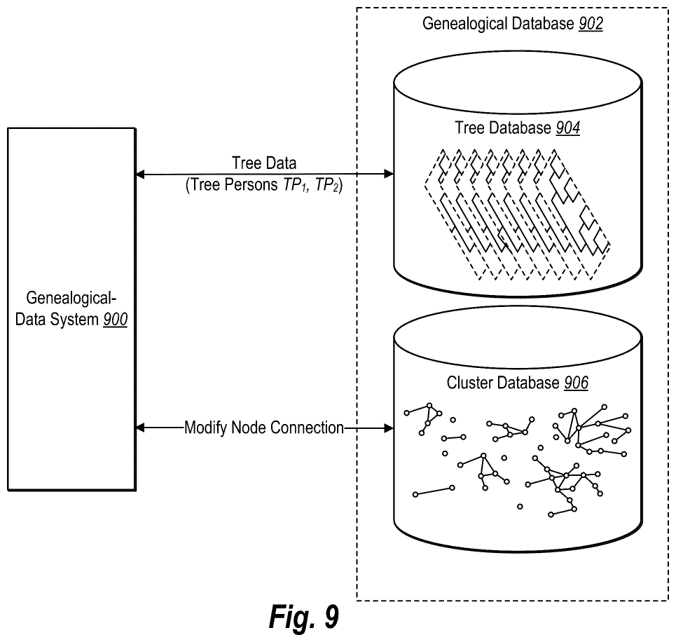

FIG. 9 illustrates a genealogical-data system 900 (e.g., the genealogical-data system 106) interfacing with a genealogical database 902 in accordance with one or more embodiments. For certain genealogical databases, the genealogical-data system 900 identifies groups of user nodes or records in the format of a genealogy tree (e.g., a universal genealogy tree of records across the genealogical-data system 900) or records connected by biological and other family relationships as “tree data.” The genealogical-data system 900 can thus search and process tree data stored in a genealogical database 902 (which includes a tree database 904 and a cluster database 906) to execute tasks and perform functions as described herein.

For the genealogical database 902, the genealogical-data system 900 may receive genealogical data (e.g., data records and/or genealogical data objects) for building tree data from a source selected from a ground-truth genealogy tree generated from genealogical records and trees of user accounts within the genealogical-data system 900, from the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, and a motor vehicle database. Additionally, genealogical data can be user-generated. Genealogical data may also include data from a cluster database 906 derived from records and user data.

Some embodiments of the model-modification system 102 relate to modifying a cluster database 906 based on a user query and/or other interaction with the model-modification system 102. In some instances, the genealogical-data system 900 (or the model-modification system 102) determines and/or modifies a node connection for an individual represented by or resolved to a cluster within the cluster database 906. Indeed, the model-modification system 102 can analyze, add, remove, and/or modify genealogical content items organized into clusters within the cluster database 906 based on relatedness corresponding to a common individual. The model-modification system 102 can also access, modify, and analyze genealogy trees within the tree database 904 by, for example, adding nodes, removing nodes, and/or modifying nodes based genealogical content items (and their relationships to individuals) stored within the cluster database 906.

As seen in FIG. 9, the genealogical-data system 900 includes a genealogical database 902, which may include a tree database 904 and a cluster database 906. The tree database 904 may be configured to facilitate the generation, storage, and collation of family trees for a plurality of users, with trees comprising nodes and edges therebetween. Data and records, such as images, may be associated with individual nodes of the trees in the tree database 904. Tree person data, including data such as names, relationships, dates, events, and other metadata may be provided by the tree database 904 to the genealogical-data system 900. The cluster database 906 may include one or more clusters comprising resolved entities, where tree persons (nodes) in different trees in the tree database 904 are associated together in a cluster after determination that the tree persons correspond to a same person.

As a user expands their family tree, e.g. by tagging a previously unknown person in an image using suggestions provided by an ancestor-identification system and adding the now-identified person to their tree as a new node, the tree database 904 may be modified as the user's family tree is expanded, and the cluster database 906 may be modified to include the new node in the pertinent cluster. Further, the model-modification system 102 can attach a conversation with a user account (e.g., a query received from the user account and a response the model-modification system 102 generates, and/or a series of queries and corresponding responses) to a cluster within the cluster database 906 and/or a node within the tree database 904 to utilize as a ground-truth genealogy tree for future operations within the genealogical-data system 900. For example, the model-modification system 102 can extract or otherwise pull contextual data from the user account or conversations with the user account (e.g., including user queries, prompts, and responses to queries or prompts) and attach the context to a node or a cluster of the cluster database 906 to utilize as a ground-truth genealogy tree for future operations within the genealogical-data system 900 and/or the model-modification system 102.

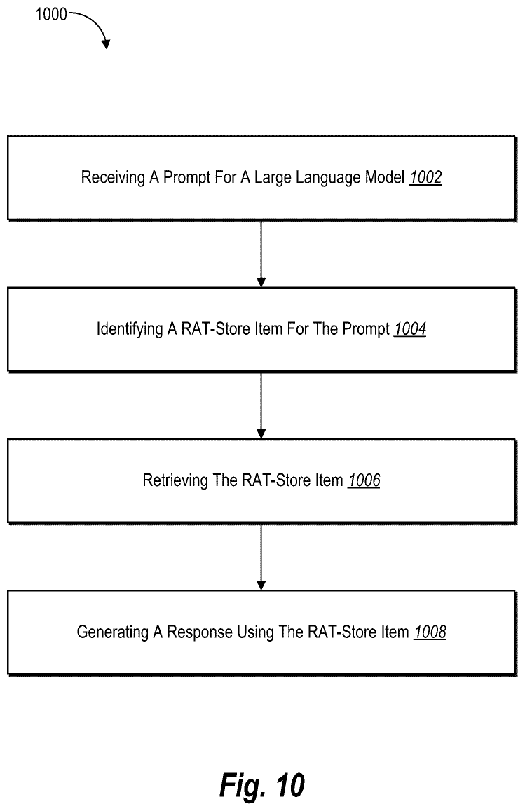

FIGS. 1-9, the corresponding text, and the examples provide a number of different systems and methods for generating responses using a large language model and RAT-store items in accordance with one or more embodiments. In addition to the foregoing, implementations can also be described in terms of flowcharts comprising acts steps in a method for accomplishing a particular result. For example, FIG. 10 illustrates an example series of acts for generating responses using a large language model and RAT-store items.

While FIG. 10 illustrates acts according to certain implementations, alternative implementations may omit, add to, reorder, and/or modify any of the acts shown in FIG. 10. The acts of FIG. 10 can be performed as part of a method. Alternatively, a non-transitory computer-readable medium can comprise instructions, that when executed by one or more processors, cause a computing device to perform the acts of FIG. 10. In still further implementations, a system can perform the acts of FIG. 10. As illustrated in FIG. 10, the series of acts 1000 includes an act 1002, an act 1004, an act 1006, and an act 1008.

As illustrated in FIG. 10, the series of acts 1000 includes an act 1002 of receiving a prompt for a large language model. In particular, the act 1002 involves receiving a prompt instructing a large language model to generate a target response. In addition, the series of acts 1000 includes an act 1004 of identifying a RAT-store item for the prompt. In particular, the act 1004 involves identifying, from among a repository of retrieval-augmented-thought (RAT) store items comprising text descriptions interpretable by the large language model to inform chain-of-thought response generation, a RAT-store item corresponding to the prompt. As shown, the series of acts 1000 includes an act 1006 of retrieving the RAT-store item. Specifically, the act 1006 involves retrieving the RAT-store item from the repository of RAT-store items. Further, the series of acts 1000 includes an act 1008 of generating a response using the RAT-store item. In particular, the act 1008 involves generating a response by utilizing the large language model to execute a sequence of processes indicated by the RAT-store item.

In some embodiments, the series of acts 1000 includes an act of encoding, using a multilingual encoder, the first reference instance to generate a first vector representation and the second reference instance to generate a second vector representation. In these or other embodiments, the series of acts 1000 includes an act of providing, using the model-selection router comprising multilingual heuristics, the first vector representation and the second vector representation to the entity-matching large language model for analysis.

The series of acts 1000 can include an act of generating the repository of RAT-store items by generating a plurality of RAT-store items, wherein: a first subset of the RAT-store items include text descriptions guiding execution of the sequence of processes by the large language model for generating the response; and a second subset of the RAT-store items include text descriptions of example data interpretable by the large language model to execute the sequence of processes for generating the response. Additionally, the series of acts 1000 may include an act of generating a hybrid RAT-store item from a first RAT-store item and a second RAT-store item from among the repository of RAT-store items by combining at least one text description from the first RAT-store item and at least one text description from the second RAT-store item into the hybrid RAT-store item.

In some embodiments, the series of acts 1000 includes an act of receiving feedback data from a client device based on the response generated by the large language model; and based on the feedback data, updating parameters of the large language model to modify how the large language model identifies relevant RAT-store items for received prompts. In at least one embodiment, the series of acts 1000 includes an act of generating a new RAT-store item to include within the repository of RAT-store items based on: determining that the repository of RAT-store items does not include a relevant RAT-store item for the prompt; and generating text describing processes executable by the large language model to generate the target response by using the large language model to model the text after existing RAT-store items within the repository of RAT-store items. Additionally, in some embodiments, the series of acts 1000 includes an act of identifying the RAT-store item, wherein the RAT-store item comprises a stored content item that includes text descriptions of the sequence of processes that, when interpreted by the large language model, instructs the large language model to execute the sequence of processes to generate the target response.

In at least one embodiment, the series of acts 1000 includes an act of determining, from the RAT-store item, a first RAT process to execute from among the sequence of processes; upon executing the first RAT process, determining, utilizing a RAT replanner, a second RAT process to execute from among the sequence of processes of the RAT-store item; and generating the response by executing the first RAT process and the second RAT process utilizing the large language model. Additionally, the series of acts 1000 may include an act of determining, upon executing the first RAT process, replanner data by utilizing the RAT replanner to determine contextual data for informing execution of the second RAT process by the large language model after execution of the first RAT process. Further, in some embodiments, the series of acts 1000 includes an act of generating the response by: determining, according to the RAT-store item, a function adapter from among a plurality of candidate function adapters, the function adapter comprising computer code executable to perform the first RAT process indicated by a text description of the sequence of processes in the RAT-store item; and identifying, utilizing the function adapter to perform the first RAT process, genealogical information corresponding to the first RAT process from a genealogical database associated with a genealogical-data system.

In some embodiments, the series of acts 1000 includes an act of receiving a prompt instructing a large language model to generate a target response; identifying, from among a repository of RAT-store items, a RAT-store item corresponding to the prompt, wherein the RAT-store item comprises a sequential text description of a sequence of processes executable by the large language model; retrieving the RAT-store item from the repository of RAT-store items; and generating a response by utilizing the large language model to execute the sequence of processes defined by the RAT-store item.

The series of acts 1000 can also include an act of identifying the RAT-store item corresponding to the prompt by: extracting a prompt embedding from the prompt; and comparing the prompt embedding to RAT-store item embeddings extracted from the RAT-store items to determine a relevant RAT-store item. Further, the series of acts 1000 may also include an act of generating the response by: determining, as informed by the RAT-store item, a content item stored in a content item database accessible by the large language model to analyze as part of the sequence of processes defined by the RAT-store item; and executing, utilizing the large language model, the sequence of processes by analyzing the content item from the content item database. In some embodiments, the series of acts 1000 includes an act of generating a hybrid RAT-store item from a first RAT-store item and a second RAT-store item from among the repository of RAT-store items by combining at least one text description from the first RAT-store item and at least one text description from the second RAT-store item into the hybrid RAT-store item.

In one or more embodiments, the series of acts 1000 includes an act of receiving a prompt instructing a large language model to generate a target response; determining that a repository of RAT-store items available to the large language model includes a RAT-store item corresponding to the prompt, wherein the RAT-store item comprises a text description of a sequence of processes executable by the large language model; retrieving the RAT-store item from the repository of RAT-store items; and generating a response by utilizing the large language model to execute the sequence of processes defined by the RAT-store item.

In one or more embodiments, the series of acts 1000 includes an act of identifying the RAT-store item corresponding to the prompt by determining, using the large language model, a relevant RAT-store item that includes text descriptions of the sequence of processes that are executable by the large language model to generate the target response indicated by the prompt. Additionally, the series of acts 1000 may include an act of receiving the prompt by receiving, from a client device, a text description of an instruction to search a genealogical database to generate the response from genealogical information.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of exemplary computing device 1100 (e.g., the server(s) 104 and/or the client device 108) that may be configured to perform one or more of the processes described above. One will appreciate that server(s) 104 and/or the client device 108 may comprise one or more computing devices such as computing device 1100. As shown by FIG. 11, computing device 1100 can comprise processor 1102, memory 1104, storage device 1106, I/O interface 1108, and communication interface 1110, which may be communicatively coupled by way of communication infrastructure 1112. While an exemplary computing device 1100 is shown in FIG. 11, the components illustrated in FIG. 11 are not intended to be limiting. Additional or alternative components may be used in other implementations. Furthermore, in certain implementations, computing device 1100 can include fewer components than those shown in FIG. 11. Components of computing device 1100 shown in FIG. 11 will now be described in additional detail.

In particular implementations, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage device 1106 and decode and execute them. In particular implementations, processor 1102 may include one or more internal caches for data, instructions, or addresses. As an example and not by way of limitation, processor 1102 may include one or more instruction caches, one or more data caches, and one or more translation lookaside buffers (TLBs). Instructions in the instruction caches may be copies of instructions in memory 1104 or storage device 1106.

Memory 1104 may be used for storing data, metadata, and programs for execution by the processor(s). Memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1104 may be internal or distributed memory.

Storage device 1106 includes storage for storing data or instructions. As an example and not by way of limitation, storage device 1106 can comprise a non-transitory storage medium described above. Storage device 1106 may include a hard disk drive (HDD), a floppy disk drive, flash memory, an optical disc, a magneto-optical disc, magnetic tape, or a Universal Serial Bus (USB) drive or a combination of two or more of these. Storage device 1106 may include removable or non-removable (or fixed) media, where appropriate. Storage device 1106 may be internal or external to computing device 1100. In particular implementations, storage device 1106 is non-volatile, solid-state memory. In other implementations, Storage device 1106 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1108 allows a user to provide input to, receive output from, and otherwise transfer data to and receive data from computing device 1100. I/O interface 1108 may include a mouse, a keypad or a keyboard, a touch screen, a camera, an optical scanner, network interface, modem, other known I/O devices or a combination of such I/O interfaces. I/O interface 1108 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1108 is configured to provide graphical data to a display for presentation to a user. The graphical data may be representative of one or more graphical user interfaces and/or any other graphical content as may serve a particular implementation.

Communication interface 1110 can include hardware, software, or both. In any event, communication interface 1110 can provide one or more interfaces for communication (such as, for example, packet-based communication) between computing device 1100 and one or more other computing devices or networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1110 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1110 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1110 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1112 may include hardware, software, or both that couples components of computing device 1100 to each other. As an example and not by way of limitation, communication infrastructure 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 12 is a schematic diagram illustrating environment 1200 within which one or more implementations of the model-modification system 102 can be implemented. For example, the model-modification system 102 may be part of a genealogical-data system 1202 (e.g., the genealogical-data system 106). The genealogical-data system 1202 may generate, store, manage, receive, and send digital content (such as genealogical content items). For example, genealogical-data system 1202 may send and receive digital content to and from client devices 1206 by way of network 1204. In particular, genealogical-data system 1202 can store and manage genealogical databases for various user accounts, historical records, and genealogy trees. In some embodiments, the genealogical-data system 1202 can manage the distribution and sharing of digital content between computing devices associated with user accounts. For instance, the genealogical-data system 1202 can facilitate a user account sharing a genealogical content item with another user account of genealogical-data system 1202.

In particular, the genealogical-data system 1202 can manage synchronizing digital content across multiple client devices 1206 associated with one or more user accounts. For example, a user may edit a digitized historical document or a node within a genealogy tree using client device 1206. The genealogical-data system 1202 can cause client device 1206 to send the edited genealogical content to the genealogical-data system 1202, whereupon the genealogical-data system 1202 synchronizes the genealogical content on one or more additional computing devices.

As shown, the client device 1206 may be a desktop computer, a laptop computer, a tablet computer, an augmented reality device, a virtual reality device, a personal digital assistant (PDA), an in-or out-of-car navigation system, a handheld device, a smart phone or other cellular or mobile phone, or a mobile gaming device, other mobile device, or other suitable computing devices. The client device 1206 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 1204.

The network 1204 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1206 may access genealogical-data system 1202.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving a prompt instructing a large language model to generate a target response;
identifying, from among a repository of retrieval-augmented-thought (RAT) store items comprising text descriptions interpretable by the large language model to inform chain-of-thought response generation, a RAT-store item corresponding to the prompt;
retrieving the RAT-store item from the repository of RAT-store items; and
generating a response by utilizing the large language model to execute a sequence of processes indicated by the RAT-store item.

2. The computer-implemented method of claim 1, further comprising generating the repository of RAT-store items by generating a plurality of RAT-store items, wherein:
a first subset of the RAT-store items include text descriptions guiding execution of the sequence of processes by the large language model for generating the response; and
a second subset of the RAT-store items include text descriptions of example data interpretable by the large language model to execute the sequence of processes for generating the response.

3. The computer-implemented method of claim 1, further comprising generating a hybrid RAT-store item from a first RAT-store item and a second RAT-store item from among the repository of RAT-store items by combining at least one text description from the first RAT-store item and at least one text description from the second RAT-store item into the hybrid RAT-store item.

4. The computer-implemented method of claim 1, further comprising:
receiving feedback data from a client device based on the response generated by the large language model; and
based on the feedback data, updating parameters of the large language model to modify how the large language model identifies relevant RAT-store items for received prompts.

5. The computer-implemented method of claim 1, further comprising generating a new RAT-store item to include within the repository of RAT-store items based on:
determining that the repository of RAT-store items does not include a relevant RAT-store item for the prompt; and
generating text describing processes executable by the large language model to generate the target response by using the large language model to model the text after existing RAT-store items within the repository of RAT-store items.

6. The computer-implemented method of claim 1, wherein the RAT-store item comprises a stored content item that includes text descriptions of the sequence of processes that, when interpreted by the large language model, instructs the large language model to execute the sequence of processes to generate the target response.

7. The computer-implemented method of claim 1, further comprising:
determining, from the RAT-store item, a first RAT process to execute from among the sequence of processes;
upon executing the first RAT process, determining, utilizing a RAT replanner, a second RAT process to execute from among the sequence of processes of the RAT-store item; and
generating the response by executing the first RAT process and the second RAT process utilizing the large language model.

8. The computer-implemented method of claim 7, further comprising determining, upon executing the first RAT process, replanner data by utilizing the RAT replanner to determine contextual data for informing execution of the second RAT process by the large language model after execution of the first RAT process.

9. The computer-implemented method of claim 7, wherein generating the response comprises:
determining, according to the RAT-store item, a function adapter from among a plurality of candidate function adapters, the function adapter comprising computer code executable to perform the first RAT process indicated by a text description of the sequence of processes in the RAT-store item; and
identifying, utilizing the function adapter to perform the first RAT process, genealogical information corresponding to the first RAT process from a genealogical database associated with a genealogical-data system.

10. A system comprising:
at least one processor; and
at least one non-transitory computer-readable storage medium storing instructions that, when executed by the at least one processor, cause the system to:
receive a prompt instructing a large language model to generate a target response;
identify, from among a repository of RAT-store items, a RAT-store item corresponding to the prompt, wherein the RAT-store item comprises a sequential text description of a sequence of processes executable by the large language model;
retrieve the RAT-store item from the repository of RAT-store items; and
generate a response by utilizing the large language model to execute the sequence of processes defined by the RAT-store item.

11. The system of claim 10, further comprising instructions that, when executed by the at least one processor, cause the system to identify the RAT-store item corresponding to the prompt by:
extracting a prompt embedding from the prompt; and
comparing the prompt embedding to RAT-store item embeddings extracted from the RAT-store items to determine a relevant RAT-store item.

12. The system of claim 10, further comprising instructions that, when executed by the at least one processor, cause the system to generate the response by:
determining, as informed by the RAT-store item, a content item stored in a content item database accessible by the large language model to analyze as part of the sequence of processes defined by the RAT-store item; and
executing, utilizing the large language model, the sequence of processes by analyzing the content item from the content item database.

13. The system of claim 10, further comprising instructions that, when executed by the at least one processor, cause the system to generate a hybrid RAT-store item from a first RAT-store item and a second RAT-store item from among the repository of RAT-store items by combining at least one text description from the first RAT-store item and at least one text description from the second RAT-store item into the hybrid RAT-store item.

14. The system of claim 10, further comprising instructions that, when executed by the at least one processor, cause the system to:
determine, from the RAT-store item, a first RAT process to execute from among the sequence of processes;
upon executing the first RAT process, determine, utilizing a RAT replanner, a second RAT process to execute from among the sequence of processes of the RAT-store item; and
generate the response by executing the first RAT process and the second RAT process utilizing the large language model.

15. The system of claim 14, further comprising instructions that, when executed by the at least one processor, cause the system to determine, upon executing the first RAT process, replanner data by utilizing the RAT replanner to determine contextual data for informing execution of the second RAT process by the large language model after execution of the first RAT process.

16. A non-transitory computer-readable medium storing instructions that, when executed by at least one processor, cause a computing device to:
receive a prompt instructing a large language model to generate a target response;
determine that a repository of RAT-store items available to the large language model includes a RAT-store item corresponding to the prompt, wherein the RAT-store item comprises a text description of a sequence of processes executable by the large language model;
retrieve the RAT-store item from the repository of RAT-store items; and
generate a response by utilizing the large language model to execute the sequence of processes defined by the RAT-store item.

17. The non-transitory computer-readable medium of claim 16, further comprising instructions that, when executed by the at least one processor, cause the computing device to identify the RAT-store item corresponding to the prompt by determining, using the large language model, a relevant RAT-store item that includes text descriptions of the sequence of processes that are executable by the large language model to generate the target response indicated by the prompt.

18. The non-transitory computer-readable medium of claim 16, further comprising instructions that, when executed by the at least one processor, cause the computing device to receive the prompt by receiving, from a client device, a text description of an instruction to search a genealogical database to generate the response from genealogical information.

19. The non-transitory computer-readable medium of claim 16, further comprising instructions that, when executed by the at least one processor, cause the computing device to:
determine, from the RAT-store item, a first RAT process to execute from among the sequence of processes;
upon executing the first RAT process, determine, utilizing a RAT replanner, a second RAT process to execute from among the sequence of processes of the RAT-store item; and
generate the response by executing the first RAT process and the second RAT process utilizing the large language model.

20. The non-transitory computer-readable medium of claim 19, further comprising instructions that, when executed by the at least one processor, cause the computing device to determine, upon executing the first RAT process, replanner data by utilizing the RAT replanner to determine contextual data for informing execution of the second RAT process by the large language model after execution of the first RAT process.
